(19) United States
(12) Patent Application Publication
(10) Pub. No.: US 2024/0316525 A1
(43) Pub. Date: Sep. 26, 2024

(54) PHOTOREACTOR ASSEMBLY

(71) Applicant: SIGNIFY HOLDING B.V., Eindhoven (NL)

(72) Inventors: ANNA WILHELMINA MARIA DE BEST, VELDHOVEN (NL); NORBERTUS ANTONIUS MARIA SWEEGERS, LIEROP (NL); REMY CYRILLE BROERSMA, EINDHOVEN (NL)

(21) Appl. No.: 18/274,501

(22) PCT Filed: Jan. 21, 2022
(86) PCT No.: PCT/EP2022/051406

§ 371 Date: Jul. 27, 2023

(30) Foreign Application Priority Data
Jan. 28, 2021 (EP) 21153909.3

(51) Int. Cl. B01J 19/12; B01J 19/00

(52) U.S. Cl. CPC B01J 19/127; B01J 19/006; B01J 19/123; B01J 19/128; B01J 2219/0892

(57) ABSTRACT

The invention provides a photoreactor assembly (1000) comprising a reactor (200) and a light source arrangement (1010): wherein: the light source arrangement (1010) comprises a plurality of light sources (10) configured to generate light source radiation (11) selected from one or more of UV radiation, visible radiation, and IR radiation, wherein each light source (10) comprises a light emitting surface (12): the reactor (200) is configured for hosting a fluid (5) to be treated with the light source radiation (11), wherein the reactor (200) comprises one or more reactor walls (210), wherein at least one of the one or more reactor walls (210) defines wall cavities (220) and is configured in a radiation receiving relationship with the plurality of light sources (10); wherein the at least one of the one or more reactor walls (210) is transmissive for the light source radiation (11); wherein one or more of the light sources (10) are at least partly configured in the wall cavities (220) whereby the light emitting surfaces (12) are within the wall cavities (220) and the at least one of the one or more reactor walls (210) at least partly encloses the light emitting surfaces (12).

### FIELD OF THE INVENTION

The invention relates to a photoreactor assembly comprising a reactor and a light source arrangement. The invention further relates to a method for treating a fluid with light source radiation.

### BACKGROUND OF THE INVENTION

Photoreactor assemblies are known in the art. For instance, US20,100,247401A1 describes a device for performing radiation assisted chemical processing including a fluid path, defined at least in part by a first surface of a wall transparent to radiation useful for performing radiation assisted chemical processing, and a gas discharge or plasma chamber arranged for producing the radiation, wherein the chamber is defined at least in part by a second surface of the transparent wall, opposite the first. It further describes a related method of forming a photocatalytic reactor comprising among other steps the step of wash-coating the fluid path so as to deposit a photocatalytic material therein, wherein the step of wash-coating includes depositing, and not depositing or removing photocatalytic material, respectively, on a first portion or from a second portion of the of non-circular cross section of the path, the second portion including at least some of the first surface of the wall of transparent material.

### SUMMARY OF THE INVENTION

Photochemical processing or photochemistry relates to the chemical effect of light. More in general photochemistry refers to a (chemical) reaction caused by absorption of light, especially ultraviolet light (radiation), visible light (radiation) and/or infrared radiation (light). Photochemistry may for instance be used to synthesize specific products. For instance, isomerization reactions or radical reactions may be initiated by light. Other naturally occurring processes that are induced by light are e.g. photosynthesis, or the formation of vitamin D with sunlight. Photochemistry may further e.g. be used to degrade/oxidize pollutants in water or e.g. air. Photochemical reactions may be carried out in a photochemical reactor or “photoreactor”.

One of the benefits of photochemistry is that reactions can be performed at lower temperatures than conventional thermal chemistry and partly for that reason thermal side reactions that generate unwanted by-products are avoided.

Furthermore, commonly used light sources in photochemistry may include low or medium pressure mercury lamps or fluorescent lamps. In addition to that, some reactions may require a very specific wavelength region, and they may even be hampered by light from the source emitted at other wavelengths. In these cases, part of the spectrum may have to be filtered out, which may lead to a low efficiency and complex reactor design.

In the recent years the output of Light Emitting Diodes (LEDs), both direct LEDs with dominant wavelengths ranging for instance from UVC to IR wavelengths, and phosphor-converted LEDs, has increased drastically, making them interesting candidates for light sources for photochemistry. High fluxes can be obtained from small surfaces, especially if the LEDs can be kept at a low temperature.

In prior art systems, a substantial proportion of the light source radiation may be unused, i.e., it does not interact with reagents/fluid in the reactor, but may instead leave the system, may be lost due to Fresnel reflection and/or may be absorbed by other elements in the system. In particular, the light source radiation may be absorbed, which may result in excessive heat being produced in the photoreactor assembly, which in turn may result in unwanted by-products and/or a reduction in the efficiency of the LEDs, and/or the light source radiation may be reflected at reactor walls and may not enter the reactor at all, or only after (multiple) reflections, which may lead to (some) loss in efficiency.

Hence, it is an aspect of the invention to provide an alternative photoreactor assembly, which preferably further at least partly obviates one or more of above-described drawbacks. The present invention may have as object to overcome or ameliorate at least one of the disadvantages of the prior art, or to provide a useful alternative. The present invention may have as object to increase the performance of a photochemical reactor by increasing the efficiency of light usage, increase the intensity and/or reducing undesired heat generation. Hence, in a first aspect, the invention may provide a photoreactor assembly (also “reactor assembly” or “assembly”) comprising a reactor and a light source arrangement. The light source arrangement may comprise a plurality of light sources configured to generate light source radiation (or: “light source light”), especially light source radiation selected from one or more of UV radiation, visible radiation, and IR radiation. In embodiments, the light source radiation may comprise UV radiation. The light source radiation may in further embodiments (also) comprise visible radiation. In yet further embodiments, the light source radiation may (also) comprise IR radiation. In embodiments, each light source may comprise a (respective) light emitting surface. The reactor may be configured for hosting a fluid (also: reactor fluid) to be treated, especially with light source radiation. The (reactor) fluid may in embodiments comprise one or more liquids. The (reactor) fluid may especially comprise one or more gases. In yet further embodiments, the fluid may comprise a mixture of gas(es) and liquid(s). The reactor may comprise one or more reactor walls. In embodiments, at least (part of) one of the one or more reactor walls defines wall cavities (or “cavities”) and is configured in a radiation receiving relationship with (at least part of) the plurality of light sources. In further embodiments, at least one of the one or more reactor walls (or “a first wall”) is transmissive for the light source radiation. In further embodiments, one or more of the plurality of light sources are at least partly configured in the wall cavities, especially whereby the light emitting surfaces are within the wall cavities and the at least one of the one or more reactor walls at least partly encloses the light emitting surfaces.

Hence, the reactor wall may have wall cavities in which light sources may be arranged. Thereby, the light sources may, during operation, be closer to a reactor fluid in the reactor. In particular, the reactor may comprise a reactor chamber configured for hosting the reactor fluid, and the reactor chamber may be arranged at least partially surrounding the wall cavities. Further, the light sources, especially the light emitting surfaces of the light sources, may be arranged such that the vast majority, essentially all, emitted light source radiation is directed towards the reactor chamber, especially towards reactor fluid in the reactor chamber. Further, the wall cavities may have a dome-like shape arranged such that loss of light source radiation due to Fresnel reflection may be reduced. In particular, the wall cavities and light sources may be arranged (relative to one another) to provide small incident angles (relative to a normal to the surface) of the light source radiation on the wall cavities. Hence, the photoreactor system of the invention may increase the efficiency of light usage, while reducing undesired heat generation.

In particular, the light sources may be arranged in the cavities such that essentially all the light (in +90°) has an incident angle on the wall cavities close to 0° (so the Fresnel reflections are kept to a minimum). Further, the reactor chamber through which the reactor fluid flows may extend over the complete curvature (of a wall cavity), so essentially all light that passes through the reactor wall may interact with the reactor fluid.

Especially, the photoreactor assembly of the invention may be relatively highly efficient in terms of light source radiation usage versus power input of the light sources. In particular, the photoreactor assembly may be highly efficient in capturing of the radiation by the fluid, especially by reactants in the fluid. In the reactor, reactions may be executed more efficiently compared to prior art solutions. Hence, a higher yield (per time unit and/or per power unit) of the desired product may be obtained in the reactor assembly compared to prior art systems.

In specific embodiments, the invention may provide a photoreactor assembly comprising a reactor and a light source arrangement; wherein: the light source arrangement comprises a plurality of light sources configured to generate light source radiation selected from one or more of UV radiation, visible radiation, and IR radiation, wherein each light source comprises a light emitting surface; and the reactor is configured for hosting a fluid to be treated with the light source radiation, wherein the reactor comprises one or more reactor walls, wherein at least one of the one or more reactor walls defines wall cavities and is configured in a radiation receiving relationship with the plurality of light sources; wherein the at least one of the one or more reactor walls is transmissive for the light source radiation;
wherein one or more of the light sources are at least partly configured in the wall cavities whereby the light emitting surfaces are within the wall cavities and the at least one of the one or more reactor walls at least partly encloses the light emitting surfaces.

Hence, the invention may provide a photoreactor assembly. The photoreactor assembly may be used for treating a (reactor) fluid with light source radiation, such as in the method of the invention. The term “treating the fluid (with light source radiation)”, and similar phrases, may especially relate to irradiating the fluid with the light source radiation. The fluid especially comprises a photosensitive reactant (including photocatalyst and/or photosensitizer), especially sensitive to the light source radiation (see below). The term “(reactor) fluid” may relate to a plurality of (different) fluids. Further, the fluid may comprise a liquid and/or a gas. Moreover, the fluid may in embodiments enter the reactor as a liquid and may in specific embodiments (partly) become gaseous when being heated in the reactor. The plurality of different fluids may be mixed and (configured to) provide a homogenous flow in the reactor during operations. In further embodiments the plurality of different fluids may be selected to provide a segmented flow in the reactor during operations. The plurality of fluids may further be selected for providing slug flow in the reactor during operations.

Hence, the fluid may have a liquid phase, a gaseous phase or a combination of liquid and gaseous phases. The fluid may comprise a mix of different fluids. The fluid may in embodiments comprise a homogenous mixture of different fluids. In further embodiments, the fluid may comprise a heterogenous mixture of fluids.

The photoreactor assembly may comprise a reactor and a light source arrangement.

The term “reactor” may especially relate to a (photo)chemical reactor. The term essentially relates to an enclosed (reactor) chamber in which a (photochemical) reaction may take place. The reactor chamber may especially have a reactor volume. In embodiments, the reactor may comprise one or more reactor walls defining the reactor chamber, especially enclosing the reactor chamber.

The term “light source arrangement” may herein refer to the arrangement of a plurality of light sources, i.e., a spatial arrangement (relative to the reactor, especially to the reactor chamber). Hence, the light source arrangement may comprise a plurality of light sources. In embodiments, the light sources may be independently arranged in the cavities. In further embodiments, the light sources may be connected to one another, such as via a support element hosting the light sources. Hence, in further embodiments, the light source arrangement may comprise a support element, such as a plate-like support element, wherein the plurality of light sources are arranged on the support element.

In embodiments (at least part of) the plurality of light sources comprise Light Emitting Diodes (LEDs), especially an array of light emitting diodes. The term “array” may especially refer to a plurality of (different) arrays. In further embodiments (at least part of) the plurality of light sources comprise Chips-on-Board light sources (COB). The term “COB” especially refers to LED chips in the form of a semiconductor chip that is neither encased nor connected but directly mounted onto a substrate, such as a Printed Circuit Board. The COB and/or LED may in embodiments comprise a direct LED (with dominant wavelengths ranging for instance from UVC to IR wavelengths) In further embodiments, the COB and/or LED comprises one or more phosphor-converted LEDs. Using such light sources, high intensity radiations (light) may be provided per light source or per light source (support) element (see below). In embodiments, e.g., the light sources may provide 100-25,000 lumen (visible light) per light source. In embodiments, the light sources may e.g. apply (consume) 0.5-500 (electrical) Watts per light source (input power).

In embodiments, the plurality of light sources may comprise (single) chips-on-board light sources and/or (single) light emitting diodes, and/or (single) laser diodes. In further embodiments, the light sources may comprise an array of light emitting diodes and/or laser diode sources. Hence, in embodiments the plurality of light sources may comprise one or more of chips-on-board light sources, light emitting diodes, and laser diodes. In further embodiments, the plurality of light sources comprise chips-on-board light sources and/or an array of light emitting diodes.

The light sources may especially be configured to generate light source radiation, especially light source radiation selected from one or more of UV radiation, visible radiation, and IR radiation.

The term “UV radiation” is known to the person skilled in the art and relates to “ultraviolet radiation”, or “ultraviolet emission”, or “ultraviolet light”, especially having one or more wavelengths in the range of about 10-400 nm, or 10-380 nm. In embodiments, UV radiation may especially have one or more wavelength in the range of about 100-400 nm, or 100-380 nm. Moreover, the term “UV radiation” and similar terms may also refer to one or more of UVA, UVB, and UVC radiation. UVA radiation may especially refer to having one or more wavelengths in the range of about 315-400 nm. UVB radiation may especially refer to having one or more wavelengths in the range of about 280-315 nm. UVC radiation may further especially have one or more wavelengths in the range of about 100-280 nm. In embodiments, the light sources may be configured to provide light source radiation having wavelengths larger than about 190 nm.

The terms “visible”, “visible light”, “visible emission”, or “visible radiation” and similar terms refer to light having one or more wavelengths in the range of about 380-780 nm.

The term “IR radiation” especially relates to “infrared radiation”, “infrared emission”, or “infrared light”, especially having one or more wavelengths in the range of 780 nm to 1 mm. Moreover, the term “IR radiation” and similar terms may also refer to one or more of NIR, SWIR, MWIR, LWIR, FIR radiation. NIR may especially relate to Near-infrared radiation having one or more wavelength in the range of about 750-1400 nm. SWIR may especially relate to Short-wavelength infrared having one or more wavelength in the range of about 1400-3000 nm. MWIR may especially relate to Mid-wavelength infrared having one or more wavelength in the range of about 3000-8000 nm. LWIR may especially relate to Long-wavelength infrared having one or more wavelength in the range of about 8-15 μm. FIR may especially relate to Far infrared having one or more wavelength in the range of about 15-1000 μm.

In embodiments, each light source may comprise a (respective) light emitting surface. The term “light emitting surface” may herein refer to the surface of the light source from which light source radiation is emitted. Especially, in embodiments the light emitting surface may be the (top) surface of a diode, such as an LED, a laser, or a superluminescent diode. In embodiments, the light emitting surface may be planar. In further embodiments, the light emitting surface may be curved, especially convex, or especially concave.

In embodiments, each light source may have an optical axis, wherein the light source emits essentially all of the light source radiation, such as at least 90% of the light source radiation, especially at least 95% of the light source radiation, such as at least 99% of the light source radiation, including 100%, at angles less than 120°, such as less than 100°, especially less than ° 90, from the optical axis.

In embodiments, each light source may have essentially Lambertian emission characteristics, i.e., the light source emits essentially all of the light source radiation at angles less than 90° with respect to the optical axis.

Especially, the optical axis may be defined as an imaginary line that defines the (weighted average) path along which light propagates through the system starting from the light generating element, here especially the light source. Hence, the optical axis may especially coincide with a weighted average path of the emitted light source radiation. In general, the optical axis may coincide with the normal to a central position of the light emitting surface.

The reactor may be configured for hosting a (reactor) fluid to be treated with the light source radiation. In particular, the reactor may comprise a reactor chamber, especially a reactor channel, configured for hosting the fluid. The term “reactor channel” may herein especially refer to a reactor chamber having an elongated shape, especially wherein, during use, the fluid flows from one end of the reactor chamber to another end of the reactor chamber. Hence, the length of the reactor channel may especially be larger than a (circular equivalent) (inner) diameter of the reactor channel. A ratio of the length of the reactor channel to the (circular equivalent) (inner) diameter of the reactor channel may in embodiments be larger than 5, especially larger than 10.

The reactor may comprise one or more reactor walls. The one or more reactor walls may define the reactor chamber, especially the reactor channel.

In embodiments, the reactor chamber, especially the reactor channel, may have a flow path, especially wherein the flow path meanders. The flow path may meander in a first dimension due to the wall cavities, which may especially penetrate the reactor chamber. The flow path may further meander in a second dimension, which may be perpendicular to the first dimension. The meandering may especially contribute to providing turbulence in the reactor chamber.

The one or more reactor walls, especially the at least one of the one or more reactor walls, may especially have an average reactor wall thickness selected from the range of 0.4-12 mm, especially from the range of 0.5-10 mm, such as from the range of 0.7-8 mm. The reactor wall thickness may (at each location) especially be measured perpendicular to the surface of a reactor wall. Due to the wall cavities, and optionally due to corrugations in the reactor wall (see below), and optionally due to a meandering flow path of the fluid, the reactor wall thickness may not be constant along the reactor. In further embodiments, along at least 80% of the at least one of the one or more reactor walls, such as at least 90%, especially at least 95%, the at least one of the one or more reactor walls may have a reactor wall thickness of at least 1 mm, especially at least 2 mm, such as at least 5 mm.

In embodiments, at least one of the one or more reactor walls may define wall cavities. In particular, the at least one of the one or more reactor walls may comprise an inner side and an outer side, wherein the inner side is directed towards the reactor chamber, and wherein the wall cavities are arranged in the outer side. Hence, in embodiments, the wall cavities may be fluidically separated from the reactor chamber. In particular, the wall cavities may be recessed relative to the outer side of the at least one of the one or more reactor walls, i.e., the wall cavities may be recessed relative to the smallest convex hull comprising the at least one of the one or more reactor walls.

In further embodiments, one or more of the wall cavities, especially each wall cavity, may have an (independently selected) dome-like shape, especially a dome-like shape selected from the group comprising a geodesic dome-shape, an ellipsoidal dome-shape, an oval dome-shape, and a hemispherical dome-shape. In particular, the wall cavity may have a dome-like shape (substantially) conform a Lambertian emission profile (like a male-female configuration).

In further embodiments, one or more of the wall cavities, especially each wall cavity, may at least partly have the shape of an essentially spherical cap.

In further embodiments, one or more of the wall cavities, especially each wall cavity, may have cross-sectional shapes at least partly complying with an essentially Gaussian shape.

Wall cavities with such shapes may provide the benefit that essentially all light source radiation provided by a light source (centrally) arranged in the wall cavity, may be incident on the at least one of the one or more reactor walls, especially on a dome segment, at an angle≤40°, such as ≤20°, which may reduce losses due to Fresnel reflection.

In further embodiments, at least 70%, such as at least 80%, especially at least 90% of the light source radiation provided by a light source (centrally) arranged in the wall cavity, may be incident on the at least one of the one or more reactor walls at an angle≤40°, such as ≤20°. In further embodiments, at least 95%, such as at least 98%, especially at least 99%, including 100% of the light source radiation provided by a light source (centrally) arranged in the wall cavity, may be incident on the at least one of the one or more reactor walls at an angle≤40°, such as ≤20°.

Regardless, some of the light source radiation may still be reflected by the one or more reactor walls, especially by the at least one of the one or more reactor walls. Hence, in embodiments, the photoreactor assembly may further comprise a reflector element (or: “reflective element”), especially wherein the reflector element is configured to reflect light source radiation. In particular, the light emitting surfaces of the one or more of the light sources may be configured between the at least one of the one or more reactor walls and the reflector element. Further, the light emitting surfaces of the one or more of the light sources may be directed towards the at least one of the one or more reactor walls, and may especially be directed away from the reflector element. Hence, the reflector element may be configured to reflect light source radiation reflected by the one or more reactor walls back to the one or more reactor walls.

The term “reflector element” especially relates to an element being able to reflect the light source radiation. Especially at least 50% of the light source radiation may be reflected when provided to the reflector element. In embodiments, the reflector element may reflect at least 60% of light source radiation incident on the reflect element, such as at least 70%, especially at least 80%. In further embodiments, the reflector element may reflect at least 90% of light source radiation incident on the reflector element, such as at least 95%.

The reflector element may e.g. comprise a (reflective) coating, or a reflective surface. In embodiments, the object comprising the reflector element may (at least partly) be made of reflective material. For instance, the object may be made of a reflective metal, or another (non-metal type) material that may reflect the light source radiation. In specific embodiments, one or more of the thermally conductive elements is made of thermally conductive material that also is reflective for the light source radiation.

The reflector element may further also comprise an optical layer. At least part of the reflector element may further e.g. comprise one or more of boron nitride (BN), alumina (Al₂O₃), aluminum, dichroic layers, a reflective polymer, and titanium dioxide (TiO₂). The optical layer may comprise a silver comprising layer (or “silver reflector”), or a dichroic layer. The layer may comprise (micro porous) polytetrafluoroethylene (PTFE). In embodiments, the reflector element comprises one or more of aluminum, boron nitride, alumina, silver, a dichroic layer, and (micro porous) PTFE.

In embodiments, one or more of the light sources may be at least partly configured in the wall cavities, especially whereby the light emitting surfaces are within the wall cavities. In particular, the one or more of the light sources may be arranged centrally in the wall cavities.

In embodiments, the at least one of the one or more reactor walls may at least partly enclose the light emitting surfaces. In particular, each wall cavity, especially each dome segment, may at least partly enclose the light emitting surface of a (respective) light source. In embodiments, a light source may be arranged in a wall cavity, wherein the light source has a light emitting surface, wherein the light emitting surface defines at least part of a plane, wherein the plane encloses a space together with the at least one of the one or more reactor walls, especially with the (respective) dome segment.

In particular, the wall cavity may be covered by a virtual plane, wherein the virtual plane and the at least one of the one or more walls (together) define an enclosed (virtual) (cavity) space. The light emitting surface may be arranged in that space, i.e., the light emitting surface may be arranged between the virtual plane and the at least one of the one or more walls, especially wherein the light emitting surface may be directed towards the at least one of the one or more walls.

In embodiments, the virtual plane may be bent, especially bent along at most one axis.

In further embodiments, the at least one of the one or more reactor walls may be configured in a radiation receiving relationship with (at least part of) the plurality of light sources. In particular, the light sources may be arranged in the wall cavities of the at least one of the one or more reactor walls, especially wherein the light sources are configured to provide light source radiation to the at least one of the one or more reactor walls.

It will be clear to the person skilled in the art that the phrase “configured to provide light source radiation to X” and similar phrases indicate that the light source radiation travels along a path crossing X. Hence, a light source may provide light source radiation to a reactor wall, wherein the light source radiation passes through the reactor wall into the reactor fluid (during operation).

In further embodiments, the at least one of the one or more reactor walls may comprise dome segments having an (independently selected) dome-like shape, especially a dome-like shape selected from the group comprising a geodesic dome-shape, an ellipsoidal dome-shape, an oval dome-shape, and a hemispherical dome-shape. The dome segments may especially define the wall cavities. In such embodiments, the dome segments may be configured in a radiation receiving relationship with (at least part of) the plurality of light sources. In particular, the light sources may be arranged in the wall cavities of the at least one of the one or more reactor walls, especially wherein the light sources are configured to provide light source radiation to dome segments. In embodiments, each light source may be configured to provide at least 60% of the emitted light source radiation to the (respective) dome segment, such as at least 70%, especially at least 80%. In further embodiments, each light source may be configured to provide at least 90% of the emitted light source radiation to the (respective) dome segment, such as at least 95%, especially at least 99%, including 100%.

In further embodiments, each light source may be configured to provide at least 60% of the emitted light source radiation to the fluid via the (respective) dome segment, such as at least 70%, especially at least 80%. In further embodiments, each light source may be configured to provide at least 90% of the emitted light source radiation to the fluid via the (respective) dome segment, such as at least 95%, especially at least 99%, including 100%. The at least one of the one or more reactor walls may, in embodiments, be (at least partly) transmissive for the light source radiation. Especially, the light source radiation provided to the at least one of the one or more reactor walls may (essentially) pass the reactor wall unhampered.

In embodiments, the one or more reactor walls, especially the at least one of the one or more reactor walls, may be made of glass. The one or more reactor walls, especially the at least one of the one or more reactor walls, may e.g. be made of quartz, borosilicate glass, soda-lime(-silica), high-silica high temperature glass, aluminosilicate glass, or soda-barium soft glass (or sodium barium glass) (PH160 glass). The glass may, e.g., be marketed as Vycor, Corex, or Pyrex. The one or more reactor walls, especially the at least one of the one or more reactor walls, is in embodiments (at least partly) made of amorphous silica, for instance known as fused silica, fused quartz, quartz glass, or quartz. The one or more reactor walls, especially the at least one of the one or more reactor walls, may in further embodiments at least partly be made of a (transmissive) polymer. Suitable polymers are e.g. poly(methyl methacrylate) (PMMA), silicone/polysiloxane, polydimethylsiloxane (PDMS), perfluoroalkoxy alkanes (PFA), and fluorinated ethylene propylene (FEP). The one or more reactor walls, especially the at least one of the one or more reactor walls, may further comprise a transmissive ceramic material. Examples of transmissive ceramics are e.g. alumina Al₂O₃, yttria alumina garnet (YAG), and spinel, such as magnesium aluminate spinel (MgAl₂O₄) and aluminum oxynitride spinel (Al₂₃O₂₇N₅). In embodiment, e.g. the one or more reactor walls, especially the at least one of the one or more reactor walls, is (at least partly) made of one of these ceramics. In yet further embodiments, the one or more reactor walls, especially the at least one of the one or more reactor walls, may comprise (be made of) transmissive materials such as BaF₂, CaF₂ and MgF₂. The material of the one or more reactor walls, especially the at least one of the one or more reactor walls, may further be selected based on the fluid to be treated. The material may especially be selected for being inert for the (compounds in) the fluid.

In further embodiments, the one or more reactor walls, especially the at least one of the one or more reactor walls, may comprise a material selected from the group comprising poly fluor alkoxy (PFA), FEP, ethylene tetra fluorethylene (ETFE), and PMMA. In particular, these materials may be transparent for UV radiation.

Photochemical reactions may be carried out in the reactor by irradiating fluid in the reactor with the light source radiation. The one or more reactor walls, especially the at least one of the one or more reactor walls, may therefore be configured to be transmissive to the light source radiation. The term “transmissive” in the phrase “transmissive to the light source radiation “especially refers to the property of allowing the light source radiation to pass through (the wall). In embodiments, the one or more reactor walls, especially the at least one of the one or more reactor walls, may be translucent for the light source radiation. Yet, in further embodiments, the one or more reactor walls, especially the at least one of the one or more reactor walls, is transparent for the light source radiation. The term “transmissive” not necessarily implies that 100% of the light source radiation provided emitted to the reactor wall may also pass through the wall. In embodiments at least 50% of the light source radiation emitted to the reactor wall may pass through the reactor wall, such as at least 70%, especially at least 90%. In further embodiments, at least 95% of the light source radiation emitted to the reactor wall may pass through the reactor wall, such as at least 98%. A relative amount of light source radiation passing through the reactor wall may e.g. depend on the wavelength of the light source radiation.

In embodiments, the at least one of the one or more reactor walls may be configured transmissive for UV radiation. In further embodiments, the at least one of the one or more reactor walls may for instance (also) be configured transmissive for visible radiation. In yet further embodiments, the at least one of the one or more reactor walls may be configured (also) transmissive for IR radiation.

In embodiments, one or more of the wall cavities may (each) host a single light source. Hence, each wall cavity may be arranged (at least partly) enclosing a (respective) light source. In particular, a single light source (of the plurality of light sources) may be arranged in each wall cavity. Each light source may especially be arranged such that at least 80%, such as at least 90% of the (respective) light source radiation is incident on the at least one of the one or more reactor walls, especially on the respective dome segment, at an angle≤40°, such as ≤20°. Thereby, losses due to Fresnel reflection may be reduced.

The term “light source” may refer to a semiconductor light-emitting device, such as a light emitting diode (LED), a resonant cavity light emitting diode (RCLED), a vertical cavity laser diode (VCSEL), an edge emitting laser, etc. . . . The term “light source” may also refer to an organic light-emitting diode, such as a passive-matrix (PMOLED) or an active-matrix (AMOLED). In embodiments, the plurality of light sources may comprise solid state light sources (such as LEDs or laser diodes). In further embodiments, the plurality of light sources may comprise one or more of chips-on-board light sources, light emitting diodes, laser diodes, and superluminescent diodes. In an embodiment, the plurality of light sources may comprise an LED. The term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB and/or a heat sink Hence, a plurality of semiconductor light sources may be configured on the same substrate. In embodiments, a COB is a multi LED chip configured together as a single lighting module. The term “light source” may also relate to a plurality of (essentially identical (or different)) light sources, such as 2-2000 solid state light sources. In embodiments, the light source may comprise one or more micro-optical elements (array of micro lenses) downstream of a single solid state light source, such as a LED, or downstream of a plurality of solid state light sources (i.e. e.g. shared by multiple LEDs). In embodiments, the light source may comprise a LED with on-chip optics. In embodiments, the light source comprises a pixelated single LED (with or without optics) (offering in embodiments on-chip beam steering). In embodiments, the light source may comprise a laser module.

The phrases “different light sources” or “a plurality of different light sources”, and similar phrases, may in embodiments refer to a plurality of solid state light sources selected from at least two different bins. Likewise, the phrases “identical light sources” or “a plurality of same light sources”, and similar phrases, may in embodiments refer to a plurality of solid state light sources selected from the same bin.

In embodiments, the wall cavities may be configured in a 2D array. Hence, the at least one of the one or more reactor walls may have a plate shape, especially a curved (or “bent”) plate shape. The term “plate shape” may herein especially refer to a shape having two dimensions that are substantially larger than a third dimension, such as at least 10 times larger, especially at least 50 times larger, such as a 100 times larger.

The term “plate shape” may herein also refer to a bent plate shape, such as the shape of a plate bent to a cylindrical shape. For example, the at least one of the one or more react walls may have a plate-like shape defining a tubular photoreactor chamber, especially a tubular photoreactor channel.

In further embodiments, wall cavities may be arranged in the at least one of the one or more reactor walls according to a regular pattern. Especially, the regular pattern may be defined according to a tessellating grid of (regular) polygons, especially a tessellating grid of squares, or especially a tessellating grid of (regular) hexagons, especially wherein a wall cavity is arranged in each grid cell, such as in the center of each grid cell.

In embodiments, the wall cavities may be arranged according to the regular pattern in a single reactor wall, especially the at least one of the one or more reactor walls, of the reactor walls. In further embodiments, wall cavities may be arranged in a plurality of reactor walls according to one or more regular patterns, especially according to two or more (different) regular patterns, or especially according to a single regular pattern.

In further embodiments, the wall cavities may have a largest circular equivalent diameter D, especially wherein the wall cavities have a pitch p_{w}, wherein 1≤p_{w}/D≤3, especially 1≤p_{w}/D≤2.

In further embodiments, the wall cavities may have a largest circular equivalent diameter D, especially wherein the light sources have a pitch p_{L}, wherein 1≤p_{L}/D≤3, especially 1≤p_{L}/D≤2.

The equivalent circular diameter (or ECD) (or “circular equivalent diameter”) of an (irregularly shaped) two-dimensional shape is the diameter of a circle of equivalent area. For instance, the equivalent circular diameter of a square with side a is 2*a*SQRT(1/π). For a circle, the diameter is the same as the equivalent circular diameter. Would a circle in an xy-plane with a diameter D be distorted to any other shape (in the xy-plane), without changing the area size, than the equivalent circular diameter of that shape would be D.

The term “pitch” may herein especially refer to the (shortest) (heart-heart) distance between repeating elements, such as in embodiments the (shortest) (heart-heart) distance between light sources in the light source arrangement, or between the centers of the wall cavities in the at least one of the one or more reactor walls. Hence, if the wall cavities are arranged according to a regular pattern of tessellating squares, the pitch may be equal (in length) to an edge (or “side”) of a square. Similarly, if the wall cavities are arranged according to a regular pattern of tessellating regular hexagons, the pitch may be equal (in length) to an edge of a hexagon.

In embodiments, at least part of the reactor may be defined by two parallel configured reactor walls. The two parallel configured reactor walls may especially define (or “provide”) a reactor volume. In embodiments, the two parallel configured reactor walls may define wall cavities and may especially be configured in a radiation receiving relationship with the plurality of light sources. As can be derived from the above, especially the reactor walls are transmissive for the light source radiation; and especially wherein one or more of the light sources are at least partly configured in the wall cavities of each of the reactor walls, especially whereby the light emitting surfaces are within the wall cavities and the reactor walls at least partly enclose the light emitting surfaces.

In further embodiments, the wall cavities may penetrate into the reactor volume. In particular, in further embodiments, the wall cavities may penetrate into a smallest convex hull comprising the reactor chamber.

In further embodiments, the reactor walls may comprise two parallel configured reactor walls, especially wherein each of the two parallel configured reactor walls has a plate shape, and especially wherein each of the two parallel configured reactor walls defines wall cavities, and especially wherein each of the two parallel configured reactor walls is transmissive for the light source radiation. In further embodiments, the two parallel configured reactor walls may especially be two oppositely arranged reactor walls, i.e., the two parallel configured reactor walls may be arranged at opposite sides of the reactor, especially of the reactor chamber.

In particular, in such embodiments, the reactor, especially the reactor chamber, may have a plate-like shape. Hence, the two parallel configured reactor walls may define at least part of the reactor, especially the reactor chamber.

In such embodiments, two or more wall cavities in a first of the two parallel configured reactor walls may (essentially) define a wall cavity in a second of the two parallel configured reactor walls. For example, if the wall cavities in the first of the two parallel configured reactor walls are arranged according to a square grid, then sets of four (2×2) wall cavities in the first of the two parallel configured reactor walls may define a wall cavity arranged between them in the second of the two parallel configured reactor walls.

In such embodiments, the plurality of light sources may be arranged in the wall cavities of both of the two parallel configured reactor walls. Hence, in further embodiments, the reactor fluid may be irradiated with light source radiation via both of the parallel configured reactor walls, especially via both of the oppositely arranged reactor walls. Therefore, in specific embodiments both reactor walls (a) may define wall cavities, (b) may be configured in a radiation receiving relationship with (light sources of) the plurality of light sources, and (c) may be transmissive for the light source radiation.

In further embodiments, the wall cavities (and the light sources) may be arranged in the two parallel configured reactor walls according to the same regular pattern. In embodiments, the regular patterns may be mirrored, i.e., when superimposing the regular patterns of the two oppositely arranged reactor walls, the regular patterns are (essentially) fully overlapping. Hence, in such embodiments, wall cavities of the parallel configured reactor walls may be arranged in parallel. Thereby, the reactor chamber may alternate between relatively narrow sections (arranged at the center of grid cells, i.e., between two wall cavities of different reactor walls) and relatively broad sections (arranged at the edges of grid cells i.e., between two wall cavities of the same reactor wall).

In particular, in such embodiments, a (wall) surface-to-volume ratio in the narrow section may be particularly high, i.e., in the narrow sections there may be a relatively large surface through which light source radiation is provided relative to the volume of fluid in the narrow section. Hence, locally the intensity of the light source radiation may be increased. Alternatively, when wall cavities of the parallel configured reactor walls are arranged in parallel, the parallel configured reactor walls may be spaced further apart as light sources in the oppositely arranged wall cavities may each illuminate (part of) the reactor fluid in the narrow section, which may allow the reactor chamber to have a larger size, especially the reactor channel to have a larger circularly equivalent diameter.

In particular, in embodiments, the parallel configured reactor walls may be separated by a first distance d1 at the narrow sections and by a second distance d2 at the broad sections. In embodiments, d2 may be selected from the range of 0.1-10 mm, such as from the range of 0.2-5 mm, especially from the range of 0.5-5 mm, and especially wherein d1/d2 is selected from the range of 0.1-0.95, such as from the range of 0.2-0.9, especially from the range of 0.5-0.9. The first distance d1 and the second distance d2 may especially correspond to circular equivalent diameters of the reactor chamber, such as circular equivalent diameters perpendicular to a flow path in the reactor chamber.

The term “node” refers to a grid point where a plurality of edges meet.

In further embodiments, the regular pattern may especially be spatially shifted for the two parallel configured reactor walls. In particular, when superimposing the regular patterns of the two parallel configured reactor walls, the centers of grid cells of a first of the two parallel configured reactor walls may align with the nodes of grid cells of a second of the two parallel configured reactor walls. Thereby, wall cavities on the parallel configured reactor walls may be spatially separated, allowing for an efficient packing of the light sources with respect to the reactor chamber. In particular, in embodiments, the wall cavities of the parallel configured reactor wall may be arranged in a staggered configuration.

The intensity of light source radiation may diminish rapidly with increased distance into the reactor chamber, especially into the reactor fluid. Hence, if the reactor fluid exhibits laminar flow, the reactor fluid may be non-uniformly exposed to the light source radiation. Hence, in embodiments, the reactor walls, especially the at least one of the one or more reactor walls, may have a corrugated shape, especially a corrugated shape at least partly defined by corrugations.

The corrugated shapes may result in turbulence for a fluid flowing in the reactor, especially in the reactor chamber. The turbulence may disrupt the laminar flow, and may thereby result in a more uniform exposure of the reactor fluid to the light source radiation.

In embodiments, the corrugations may comprise the wall cavities. In further embodiments, the corrugations may define the wall cavities.

The corrugated shape may, in embodiments, be defined by 1D corrugations.

Hence, the reactor walls, especially the at least one of the one or more reactor walls, may have a first dimension along which cross-sections of the reactor walls are essentially straight lines, and a second dimension, perpendicular to the first dimension, along which cross-section of the reactor walls approximate a wave shape, such as approximate a sine wave shape.

In further embodiments, the corrugated shapes may be defined by 2D corrugations. Hence, the reactor walls, especially the at least one of the one or more reactor walls, may have a first dimension and a second dimension perpendicular to the first dimension, wherein cross-section of the reactor walls along the first dimension and the second dimension approximate a wave shape, such as approximate a sine wave shape. In further embodiments, the photoreactor assembly may comprise reactor walls, especially two parallel configured reactor walls sandwiched between reflector elements.

In embodiments, the photoreactor assembly, especially the reactor chamber, or especially the reactor volume, may host flow influencing elements. In particular, the one or more reactor walls may comprise (or “define”) the flow influencing elements. The flow influencing elements may especially be configured to increase turbulence for the reactor fluid.

In further embodiments, the flow influencing elements may be selected from the group comprising protrusions, obstacles, bars, sills, and strictures.

The flow influencing elements may especially be configured within the reactor, especially within the reactor chamber, between adjacent wall cavities.

Hence, in embodiments, a reactor wall may comprise an inner wall for contacting the reactor fluid, wherein the reactor wall comprises a flow influencing element arranged on the inner wall. The flow influencing element may especially be arranged between adjacent wall cavities in the reactor wall.

In further embodiments, the inner wall may be shaped to facilitate creation of turbulence, such as by causing Eddies.

In further embodiments, each wall cavity may define a reactor section surrounding the wall cavity. In particular, the reactor chamber, may be divided into a plurality of reactor sections corresponding to the plurality of wall cavities, wherein each reactor section comprises the part of the reactor closest to the respective wall cavity. Hence, each reactor section may be primarily irradiated by the light source arranged in the (respective) wall cavity.

The reactor chamber may especially be divided into a plurality of reactor sections and inter reactor section channels, wherein adjacent reactor sections may be fluidly connected via the inter reactor section channels.

In further embodiments, dimensions of the inter reactor section channels may be selected such that a flow velocity [m/s] of the fluid in the inter reactor section channels is higher than in the reactor sections, especially at least 1.5 times higher, such as 2 times higher. In further embodiments, the flow velocity [m/s] of the fluid in the inter reactor section channels may be at least 3 times higher than in the reactor section, such as at least 5 times higher. Thereby, an increased flow rate in the inter reactor section channels relative to the reactor sections may result in the fluid being exposed to the light source radiation for a relatively larger proportion of the time.

The photoreactor assembly may, in embodiments, comprise a temperature control element, especially a temperature control channel. The temperature control element may be configured to control the temperature of the reactor, especially of the reactor fluid.

The temperature control element may especially comprise a cooling element.

In embodiments, the temperature control element may comprise a temperature control channel. The term “temperature control channel” especially relates to a channel/path configured in the photoreactor assembly which may hold a temperature control (or cooling) fluid, especially through which a fluid may flow (such as by a forced transport or spontaneously). The term temperature control channel” may in embodiments refer to a plurality of (different) temperature control channels. The temperature control fluid, especially the cooling fluid, may be a gas, such as air. The temperature control fluid may also be a liquid, such as water. The temperature control fluid may further be known as “a coolant”. The temperature control channel is especially configured in functional contact (especially in thermal contact) with the reactor, especially with the reactor fluid. The temperature control fluid may be configured for cooling the (reactor) fluid, especially the reactor. Temperature controlling may in embodiments of the invention especially be explained based on reducing the temperature, and as such temperature controlling may herein mostly be described as cooling. Yet, in alternative embodiments temperature controlling may comprise increasing a temperature. Hence, it will be understood that if the element is explained in relation to cooling, the element may in alternative embodiments be used for heating. As such in embodiments the term “cooling” may be exchanged with the term “heating” (or “temperature control(ling)”).

In specific embodiments, the reactor, especially the reactor chamber, or especially the reactor volume may be configured traversed with one or more temperature control channels.

In embodiments wherein the reactor comprises a reactor channel, the temperature control channel may be arranged (essentially) perpendicular to the reactor channel, especially wherein the reactor comprises a plurality of reactor channels and a plurality of temperature control channels arranged in a grid.

In embodiments, the temperature control channel may (at least partially) be arranged in the reactor chamber, i.e., the reactor fluid may be in (direct) fluid contact with the (outside of the) temperature control channel.

In further embodiments, the temperature control channel may be arranged at a distance from the reactor chamber, i.e., the reactor fluid may be fluidically separated from the temperature control channel. In such embodiments, a thermally conductive material may be arranged between the reactor chamber and the temperature control channel. For instance, a second reactor wall (of the reactor walls) may comprise a thermally conductive material, wherein the temperature control channel is arranged in the second reactor wall.

In further embodiments, the temperature control channel may especially be arranged at least partially parallel to the reactor channel and be in thermal contact therewith (via the at least partial parts). Thereby, the area along which the temperature control channel and the reactor channel are in thermal contact may be relatively larger, which may facilitate increased temperature control.

Herein, the term “thermal contact” may especially refer to an arrangement of elements that may provide a thermal conductivity of at least about 10 W/m/K, such as at least 20 W/m/K, such as at least 50 W/m/K. In embodiments, the term “thermal contact” may especially refer to an arrangement of elements that may provide a thermal conductivity of at least about 150 W/m/K, such as at least 170 W/m/K, especially at least 200 W/m/K. In embodiments, the term “thermal contact” may especially refer to an arrangement of elements that may provide a thermal conductivity of at least about 250 W/m/K, such as at least 300 W/m/K, especially at least 400 W/m/K. For instance, a metal support for a light source, wherein the metal support is in physical contact with the light source and in physical contact with a channel wall of a fluid transport channel, wherein the light source is not in the fluid transport channel, may provide a thermal conductivity between the light source and the fluid transport channel of at least about 10 W/m/K. Suitable thermally conductive materials, that may be used to provide the thermal contact, may be selected from the group (of thermally conductive materials) consist of copper, aluminum, silver, gold, silicon carbide, aluminum nitride, boron nitride, aluminum silicon carbide, beryllium oxide, a silicon carbide composite, aluminum silicon carbide, an copper tungsten alloy, a copper molybdenum carbide, carbon, diamond, and graphite. Alternatively, or additionally, the thermally conductive material may comprise or consist of a ceramic material, such aluminum oxide of a garnet of the YAG-type family, such as YAG. Especially, the thermally conductive material may comprise e.g. copper or aluminum.

Hence, in embodiments, one or more of a spectral power distribution of the light source radiation and an intensity of the light source radiation may be controllable, especially the spectral power distribution, or especially the intensity.

In specific embodiments, two or more of the plurality of light sources may provide light source radiation having different spectral power distributions. For instance, a first light source may be configured to generate UV radiation and a second light source may be configured to generate visible radiation. In specific embodiments, the photoreactor assembly may comprise two or more light sources configured at different positions along the reactor chamber, especially along a flow path of the fluid.

The term “wavelength” may herein also relate to a plurality of wavelengths. The term may especially refer to a wavelength distribution.

In further embodiments, the photoreactor assembly may further comprise a control system. The control system may especially be configured to control the photoreactor assembly. For instance, in embodiments, the control system may be configured to control a flow of fluid through the reactor. In further embodiments, the control system may be configured to control a composition of the fluid. In further embodiments, the control system may be configured to (independently) control the plurality of light sources. In further embodiments, the control system may be configured to control the temperature control element.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. . . . Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions form a remote control. In embodiments, the control system may be controlled via an App on a device, such as a portable device, like a Smartphone or I-phone, a tablet, etc. . . . The device is thus not necessarily coupled to the lighting system, but may be (temporarily) functionally coupled to the lighting system.

The system, or apparatus, or device may execute an action in a “mode” or “operation mode” or “mode of operation”. Likewise, in a method an action or stage, or step may be executed in a “mode” or “operation mode” or “mode of operation” or “operational mode”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

During use of the photoreactor assembly, it may be beneficial to temporally and/or spatially vary the spectral power distribution of the light source radiation. For instance, different spectral power distributions may be successively provided to the reactor, especially to the reactor chamber, more especially to the fluid, for successive chemical reactions, or for controlling, for instance, algal growth phenotypes. Similarly, it may be beneficial to temporally and/or spatially vary the intensity of the light source radiation. Hence, in embodiments, the control system may be configured to temporally vary one or more of the spectral power distribution and the intensity of the light source radiation, especially the spectral power distribution, or especially the intensity. In further embodiments, the control system may be configured to control the one or more of the spectral power distribution and the intensity of the light source radiation, especially the spectral power distribution, or especially the intensity, along one or more dimensions of the reactor. In further embodiments, the one or more dimensions of the reactor may be selected from the group of height, length, width, and (circular equivalent) diameter.

It will be clear to the person skilled in the art, that also a combination of temporal and spatial control is possible.

In embodiments, the reactor fluid may flow through the reactor, especially the reactor chamber, or especially the reactor volume, along a fluid path. In particular, the reactor may comprise a reactor inlet and a reactor outlet, wherein the reactor fluid, during use of the reactor, flows from the reactor inlet to the reactor outlet along the fluid path, i.e., the fluid path may be a path through the reactor chamber from the reactor inlet to the reactor outlet.

In embodiments, the fluid path may be arranged along (or “encounter”) at least 5 wall cavities, such as at least 10 wall cavities, especially at least 20 wall cavities. In further embodiments, the fluid path may be arranged along at least 50 wall cavities, such as at least 100 wall cavities.

In further embodiments, at least 5 light sources, such as at least 10 light sources, especially at least 20 light sources, may be arranged to irradiate (fluid flowing along) the fluid path. In further embodiments, at least 50 light sources, such as at least 100 light sources, may be arranged to irradiate (fluid flowing along) the fluid path. In particular, in embodiments, each wall cavity arranged along the fluid path may comprise a (single) light source configured to irradiate (fluid flowing along) the fluid path.

The reactor assembly may be used for treating a fluid. As a result, (photosensitive) reactants in the fluid may react. Moreover, the term “treating the fluid with light source radiation” may in embodiments relate to executing a (photochemical) reaction on (reactants in) the fluid.

Herein also the term “irradiating the fluid” such as in the phrase “irradiating the fluid with the light source radiation” is used. The term may especially relate to providing light source radiation to the fluid. Hence, herein the terms “providing light source radiation (to the fluid)” and the like and “irradiating (the fluid with) light source radiation” may especially be used interchangeably. Moreover, herein the terms “light” and “radiation” may be used interchangeably, especially in relation to the light source radiation.

The light source arrangement may, in embodiments, comprise a plurality of light sources arranged on a (monolithic) support element. The support element may, during use, especially be removably attached to the at least one of the one or more reactor walls. Thereby, the light sources may be conveniently (properly) arranged (all at once) in the wall cavities, and the light source arrangement may be conveniently detached from the reactor wall in order to access one or more of the plurality of light sources. Further, such configuration may allow easy assembling of the photoreactor assembly and may further allow for a quick change of one or more of the light sources (e.g. when another radiation wavelength is desired).

In embodiments, the support element may comprise the reflector element, especially wherein the reflector element comprises a reflective coating.

In further embodiments, the support element may be thermally conductive, i.e., the support element may comprise a thermally conductive material. In further embodiments, the support element may be thermally coupled to the temperature control channel. In further embodiments, the support element may comprise or be thermally coupled to a heat sink.

The light sources may especially be arranged on the support element in a manner compatible with the (regular) pattern of wall cavities in the at least one of the one or more reactor walls. In particular, one or more light sources may be arranged on a support member, wherein the support member is arranged on the support element. The support member may be configured to improve and/or standardize the arrangement of the light source in the wall cavity. In embodiments, the support member may be configured to elevate (or “distance”) the light source with respect to the support element. In further embodiments, the support member may be configured to arrange the (light emitting surface of the) light source at an angle to the support element.

In a further aspect, the invention may provide a method for treating a fluid with light source radiation. Especially, the method may comprise providing the fluid (to be treated with the light source radiation) in the reactor, especially in the reactor chamber, of the photoreactor assembly according to any one of the preceding claims. The method may further comprise irradiating the fluid with the light source radiation.

Hence, in specific embodiments, the invention provides a method for treating a fluid with light source radiation, wherein the method comprises: providing the fluid to be treated with the light source radiation in the reactor of the photoreactor assembly according to the invention; and irradiating the fluid with the light source radiation.

In embodiments, the method may comprise transporting the fluid through the reactor, especially while irradiating the fluid with the light source radiation.

In further embodiments, the method may comprise controlling one or more of a spectral power distribution and an intensity, especially a spectral power distribution, or especially an intensity, of the light source radiation along one or more dimensions of the reactor. The one or more dimensions of the reactor may especially be selected from the group comprising height, length, width, and (circular equivalent) diameter.

Irradiating the fluid with the light source radiation may induce a photochemical reaction. In embodiment, the (photochemical) reaction comprises a photocatalytic reaction. In embodiments, the method further comprises providing a photocatalyst and or photosensitizer to the (reactor) fluid prior to and/or during irradiating the (reactor) fluid with the light source radiation.

In embodiments, the method comprises a batch process. In other embodiments, the method comprises a continuous process. Hence, in specific embodiments, the method comprises transporting the fluid through the reactor while irradiating the fluid with the light source radiation.

The photoreactor assembly may especially comprise one or more temperature control elements (described herein). The method may further comprise transporting a temperature control fluid through and/or along one or more of the temperature control elements.

In yet further embodiments, the method comprises selecting the light source radiation from one or more of UV radiation, visible radiation, and IR radiation, prior to irradiating the fluid with the light source radiation. The light source radiation may especially be selected by selecting the plurality of light sources to generate the (selected) light source radiation. The light source radiation may further be selected based on the fluid to be treated, especially a (photosensitive) reactant and/or photocatalyst and/or photosensitizer in the fluid.

In further embodiments, one or more of the light sources are controlled to radiate different intensities and/or wavelength distributions.

In further embodiments, the dome-like shape of the wall cavities may at least partly have the shape of a spherical cap.

Many photochemical reactions are known, such as dissociation reactions, isomerization or rearrangement reactions, addition reactions and substitution reactions, and, e.g., redox reactions. In embodiments, the (photochemical) reaction comprises a photocatalytic reaction. Photochemical reactions may especially use the energy of the light source radiation to change a quantum state of a system (an atom or a molecule) (that absorbs the energy) to an excited state. In the excited state, the system may successively further react with itself or other systems (atoms, molecules) and/or may initiate a further reaction. In specific embodiments, a rate of the photochemical reaction may be controlled by an added (photo-)catalysts or photosensitizer. The terms “treating”, “treated” and the like, used herein, such as in the phrase “treating a fluid with the light source (light)” may especially thus relate to performing a photochemical reaction on a relevant (especially photosensitive) system (atom or molecule) in the fluid, especially thereby elevating the system (atom, molecule) to a state of higher energy and especially causing the further reaction. In embodiments a photoactive compound may be provided to the fluid prior and/or during the irradiation of the fluid. For instance, a photocatalyst and/or a photosensitizer may be added to start and/or promote/accelerate the photochemical reaction.

Herein, such atom or molecule may further also be named “a (photosensitive) reactant”. Hence, the reactor fluid may comprise a (photosensitive) reactant.

When absorbing (light source) radiation (light), energy of a photon may be absorbed. The photon energy may also be indicated as hv, wherein h is Planck's constant and v is the photon's frequency. Hence, the amount of energy provided to the atom or molecule may be provided in discrete amounts and is especially a function of the frequency of the light (photon). Furthermore, the excitation of an atom or a molecule to a higher state may also require a specific amount of energy, which preferably is matched with the amount of energy provided by the photon. This may also explain that different photochemical reactions may require light having different wavelength. Therefore, in embodiments, the photoreactor assembly may be configured to control a wavelength of the light source radiation.

The embodiments described herein are not limited to a single aspect of the invention. For example, an embodiment describing the method may, for example, further relate to the system, especially to an operational mode of the system, or especially to the control system. Similarly, an embodiment of the system describing an operation of the system may further relate to embodiments of the method. In particular, an embodiment of the method describing an operation (of the system) may indicate that the system may, in embodiments, be configured for and/or be suitable for the operation. Similarly, an embodiment describing an operation (of the system) may indicate that the method may, in embodiments, comprise that operation.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-D schematically depict embodiments of the photoreactor assembly.

FIG. 2A-B schematically depicts an embodiment of the photoreactor assembly.

FIG. 3A-B schematically depict embodiments of the photoreactor assembly. The schematic drawings are not necessarily on scale.

### DETAILED DESCRIPTION OF THE EMBODIMENTS

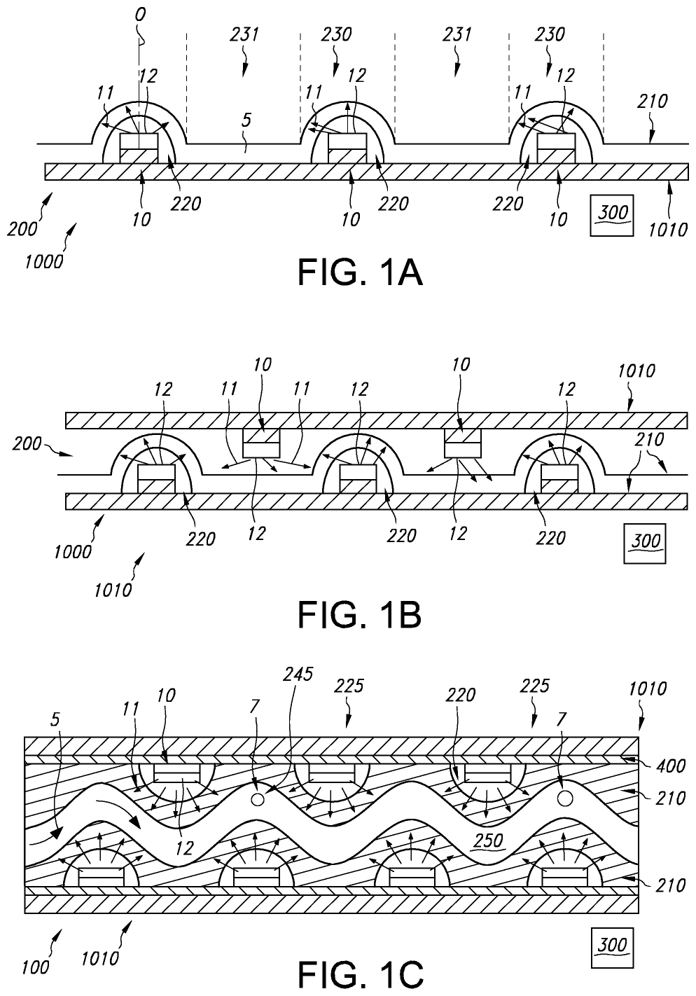

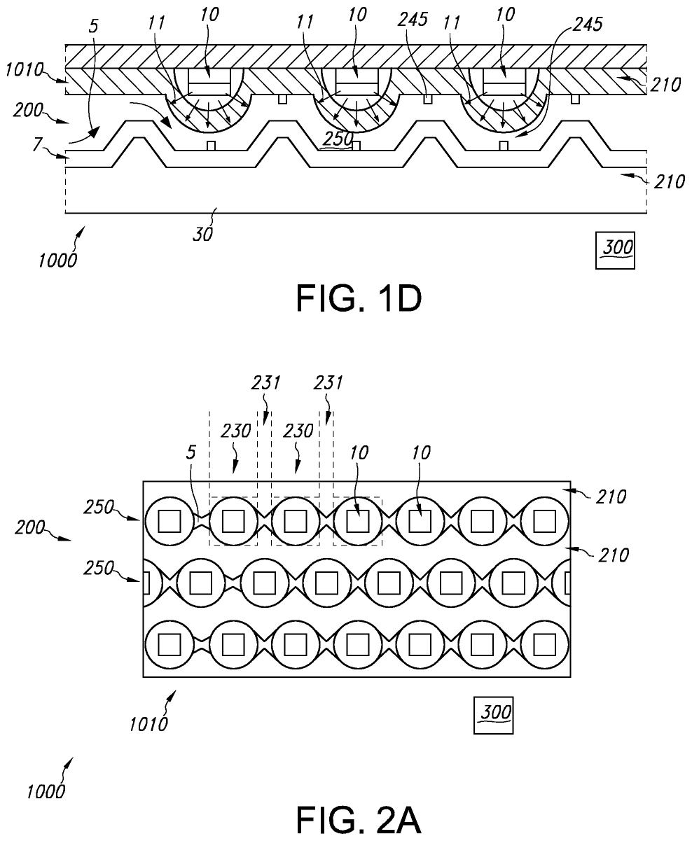

FIG. 1A schematically depicts an embodiment of the photoreactor assembly 1000. The photoreactor assembly comprises a reactor 200 and a light source arrangement 1010. The light source arrangement 1010 comprises a plurality of light sources 10 configured to generate light source radiation 11, especially light source radiation 11 selected from one or more of UV radiation, visible radiation, and IR radiation. In particular, each light source 10 may comprise a light emitting surface 12, wherein the light emitting surface 12 emits the light source radiation 11. The reactor 200 may be configured for hosting a fluid 5 to be treated with the light source radiation 11. The reactor 200 may comprise one or more reactor walls 210, especially wherein at least one of the one or more reactor walls 210 defines wall cavities 220 and is configured in a radiation receiving relationship with the plurality of light sources 10. In embodiments, the at least one of the one or more reactor walls 210 may be transmissive for the light source radiation 11.

In the depicted embodiment, one or more of the light sources 10 are at least partly configured in the wall cavities 220, especially whereby the light emitting surfaces 12 are within the wall cavities 220. Especially, the at least one of the one or more reactor walls 210 at least partly encloses the light emitting surfaces 12. In the depicted embodiment, one or more of the wall cavities 220 (each) host a single light source 10. The wall cavities 220 may especially have a dome-like shape, such as depicted in FIG. 1A. The dome-like shape may reduce the (undesired) reflection of light source radiation 11 from the light source 10 at the one or more reactor walls 210. In embodiments, one or more of the wall cavities 220 may at least partly have the shape of a spherical cap, and/or one or more of the wall cavities 220 may have cross-sectional shapes at least partly complying with a Gaussian shape. In embodiments, each wall cavity 220 may define a reactor section 230 surrounding the wall cavity 220, wherein adjacent reactor sections 230 are fluidly connected via inter reactor section channels 231. Hence, each wall cavity 220 may comprise a (respective) light source 10 configured to provide light source radiation 11 to fluid 5 in the (respective) reactor section 230.

In embodiments, the photoreactor assembly 1000 may further comprise a control system 300. The control system 300 may be configured to control the photoreactor assembly 1000, especially the light source arrangement 1010. In further embodiments, the control system 300 may be configured to control one or more of the spectral power distribution and the intensity of the light source radiation 11 along one or more dimensions of the reactor 200, especially wherein the one or more dimensions of the reactor 200 are selected from the group of height, length, width, and (circular equivalent) diameter.

FIG. 1B-C schematically depict further cross-sections of embodiments of the photoreactor assembly 1000. In the depicted embodiments, at least part of the reactor 200 is defined by two parallel configured reactor walls 210 providing a reactor volume.

FIG. 1C schematically depicts an embodiment wherein the photoreactor assembly 1000 further comprises a reflector element 400. The reflector element 400 may especially be configured to reflect light source radiation 11. Hence, in embodiments, the light emitting surfaces 12 of the one or more of the light sources 10 may be configured between the at least one of the one or more reactor walls 210 and the reflector element 400.

In the depicted embodiment. the reactor walls 210 may be configured sandwiched between the reflector elements 400.

Specifically, the two parallel configured reactor walls 210 may define a reactor chamber 250 configured to host the reactor fluid. Hence, the reactor 200 may comprise a reactor chamber 250 configured to host the reactor fluid 5. The reactor chamber 250 may especially have a reactor volume. In the depicted cross-section, the reactor chamber 250 may have a wave-like pattern along a flow direction of the reactor fluid 5 due to the presence of the wall cavities 220. Hence, the wall cavities 220 may penetrate into the reactor chamber 250, especially into the reactor volume.

In specific embodiments, the two parallel configured reactor walls 210 may define wall cavities 220 and may be configured in a radiation receiving relationship with the plurality of light sources 10; especially wherein the reactor walls 210 are transmissive for the light source radiation 11; and especially wherein one or more of the light sources 10 are at least partly configured in the wall cavities 220 of each of the reactor walls 210, and especially whereby the light emitting surfaces 12 are within the wall cavities 220 and the reactor walls 210 at least partly enclose the light emitting surfaces 12.

In the depicted embodiment, the reactor walls 210 have corrugated shapes at least partly defined by corrugations 225. In particular, the corrugations 225 may comprise the wall cavities 220.

The corrugations 225 may increase turbulence of the reactor fluid 5 in the reactor chamber 250, which may “refresh” the reactor fluid 5 exposed to the light source radiation 11.

In particular, in embodiments, the reactor chamber 250, especially the reactor volume, may host flow influencing elements 245, especially wherein the flow influencing elements 245 are configured to increase turbulence, and especially wherein the flow influencing elements 245 are configured within the reactor between adjacent wall cavities 220.

The flow influencing elements 245 may further be configured to influence, especially slow, a flow of the reactor fluid 5.

Although the arrangement of the light sources 10 in the wall cavities 220 having dome-like shapes may reduce Fresnel reflection, which may reduce heat generation (see above), it may still be beneficial to control the temperature of the reactor fluid 5 and/or of the light sources 10.

Hence, in embodiments, the reactor chamber 250, especially the reactor volume, may be configured traversed with one or more temperature control channels 7.

Such configuration may provide the further benefit that the temperature control channels 7 may serve as flow modifying elements 245, and may especially provide turbulence of the reactor fluid 5 in the reactor chamber 250.

FIG. 1D schematically depicts a further embodiment of the photoreactor assembly 1000. In the depicted embodiment, the reactor 200 comprises a reactor wall 210 with wall cavities 220 for hosting the light sources 10, and a second reactor wall 210 comprising a thermally conductive material 30. In the depicted embodiment, a temperature control channel 7 is configured (essentially) in the second reactor wall 210, and the temperature control channel 7 is configured parallel to the reactor chamber 250, i.e., the temperature control channel 7 is arranged along the reactor chamber 250, especially along a reactor channel.

In further embodiments, the reactor 200 may comprise a plurality of temperature control channels 7, especially wherein at least part of the temperature control channels 7 are arranged traversed in the reactor chamber 250, or especially wherein at least part of the temperature control channels 7 are arranged parallel to the reactor chamber 250.

FIG. 1A-D further schematically depict embodiments of a method for treating a fluid 5 with light source radiation 11. The method may comprise providing the fluid 5 to be treated with the light source radiation 11 in the reactor 200, especially in the reactor chamber 250, of the photoreactor assembly 1000; and irradiating the fluid 5 with the light source radiation 11.

In embodiments, the method may comprise transporting the fluid 5 through the reactor 200 while irradiating the fluid 5 with the light source radiation 11.

In further embodiments, the method may comprise controlling one or more of a spectral power distribution and an intensity of the light source radiation 11 along one or more dimensions of the reactor 200, especially wherein the one or more dimensions of the reactor 200 are selected from the group of height, length, width, and diameter.

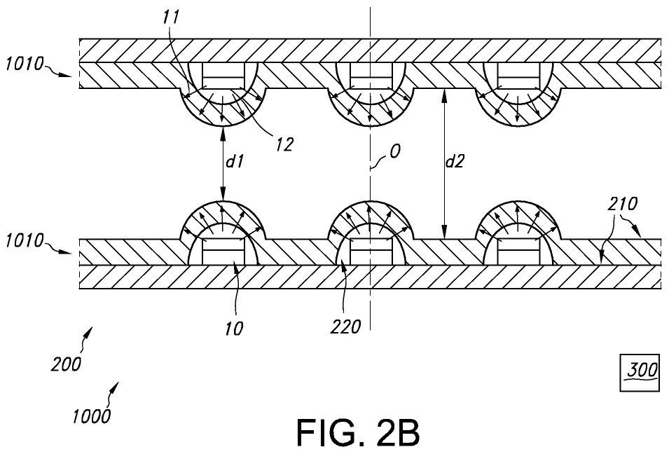

FIG. 2A schematically depicts a top view of the photoreactor assembly 1000. In the depicted embodiment, the photoreactor assembly 1000 comprises reactor walls 210 defining three reactor chambers 250, wherein each reactor chamber 250 comprises a plurality of reactor sections 230 and inter reactor section channels 231. Specifically, in the depicted embodiment, the dimensions of the inter reactor section channels 231 may be selected such, that a flow velocity (in m/s) of the fluid 5 in the inter reactor section channels 231 is higher than in the reactor sections 230.

FIG. 2A further schematically depicts a top view of a photoreactor assembly 1000 comprising a single reactor chamber 250 divided into three (main) canals. In such embodiments, the inter reactor section channels 231 may especially be fluidically coupled, and may especially be arranged in line (i.e., the middle canal may be shifted to the left to vertically align the inter reactor section channels 231).

Hence, in embodiments, the reactor chamber 250 may comprise a plurality of parallel arranged canals, wherein each canal comprises a plurality of reactor sections 230 and inter reactor section channels 231, wherein at least two inter reactor section channels 231 of different canals are in (direct) fluid contact. In further embodiments, at least two adjacently arranged canals may be aligned with respect to their reactor sections 230 and inter reactor section channels 231.

In embodiments the inter reactor section channels 231 may especially vary with respect to length, width and height. Thereby, the flow rate between adjacent reactor sections 230 may be modulated. In further embodiments, the inter reactor section channels 231 may especially have (essentially) the same length, width, and height.

FIG. 2B schematically depicts an embodiment wherein wall cavities 220 of two oppositely arranged reactor walls 210 are arranged in parallel. In particular, two light sources 10 arranged in oppositely arranged wall cavities 220 may share their optical axis O. In such a configuration, the reactor chamber 250 may have (relatively) narrow sections arranged between oppositely arranged light sources 10 (along the optical axis O), and may have (relatively) broad sections arranged between light sources along 10a flow path. In particular, in embodiments, the parallel configured reactor walls may be separated by a first distance d1 at the narrow sections and by a second distance d2 at the broad sections. In embodiments, d2 may be selected from the range of 0.1-10 mm, such as from the range of 0.2-5 mm, especially from the range of 0.5-5 mm, and especially wherein d1/d2 is selected from the range of 0.1-0.95, such as from the range of 0.2-0.9, especially from the range of 0.5-0.9

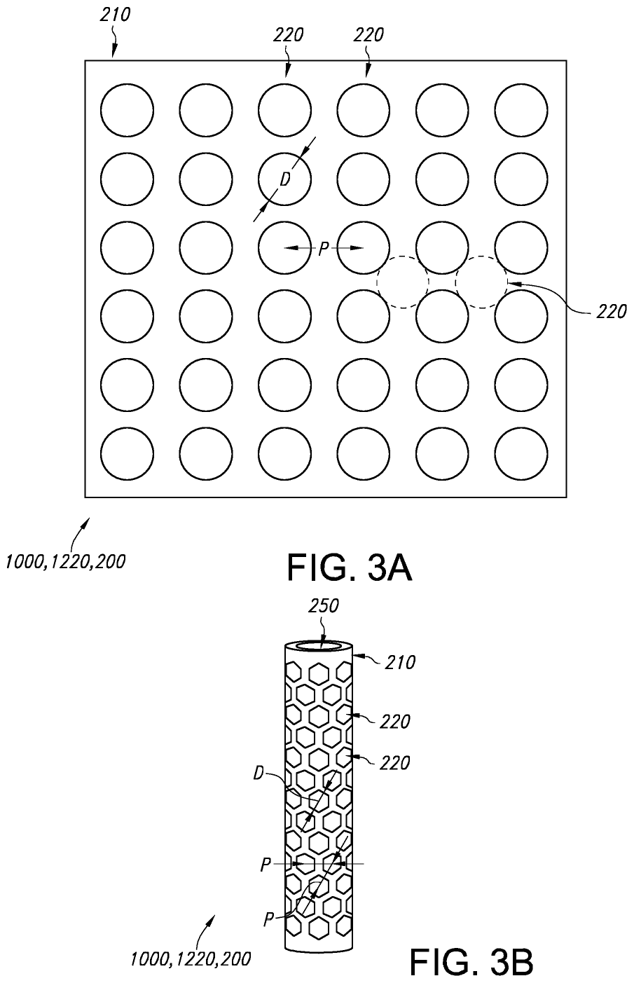

FIG. 3A-B schematically depict embodiments of the photoreactor assembly 1000, wherein the wall cavities 220 are configured in a 2D array 1220.

FIG. 3A schematically depicts a cross-sectional view of the first reactor wall 210, wherein the wall cavities 220 are configured in a (regular) 2D array 1220 of squares, wherein each square comprises a wall cavity 220. In particular, the wall cavities 220 may have a largest circular equivalent diameter D, wherein the light sources 10 have a pitch p, wherein 1≤p/D≤2.

In embodiments, the first reactor wall 210 may be arranged parallel to a second reactor wall 210 (not depicted), wherein the second reactor wall also comprises wall cavities 220, especially also configured according to the (regular) 2D array of squares. In particular, in the depicted embodiment, the 2D arrays of squares of the first reactor wall 210 and the second reactor wall 210 are shifted with respect to one another, especially such that the centers of the array of the reactor wall 210 are superimposed on the nodes of the array of the second reactor wall 210. For visualization purposes two wall cavities 220 of the second wall are depicted as hyphenated circles.

Hence, in embodiments, two or more wall cavities 220 in a first of two parallel configured reactor walls 210 may (essentially) define a wall cavity 220 in a second of the two parallel configured reactor walls 210. In the depicted embodiment, sets of four (2×2) wall cavities 220 in the first of the two parallel configured reactor walls 210 define a wall cavity 220 arranged between them in the second of the two parallel configured reactor walls 210.

FIG. 3B schematically depicts a reactor 200 having a cylindrical shape, especially wherein the reactor wall 210 has a cylindrical shape. The depicted reactor wall 210 defines wall cavities 220 according to a (regular) 2D array of (regular) hexagons, wherein each hexagon comprises a wall cavity 220.

The term “plurality” refers to two or more. Furthermore, the terms “a plurality of” and “a number of” may be used interchangeably.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. Moreover, the terms “about” and “approximately” may also relate to 90% or higher, such as 95% or higher, especially 99% or higher, even more especially 99.5% or higher, including 100%. For numerical values it is to be understood that the terms “substantially”, “essentially”, “about”, and “approximately” may also relate to the range of 90%-110%, such as 95%-105%, especially 99%-101% of the values(s) it refers to.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

The term “further embodiment” and similar terms may refer to an embodiment comprising the features of the previously discussed embodiment, but may also refer to an alternative embodiment.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, “include”, “including”, “contain”, “containing” and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings. Moreover, if a method or an embodiment of the method is described being executed in a device, apparatus, or system, it will be understood that the device, apparatus, or system is suitable for or configured for (executing) the method or the embodiment of the method, respectively.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A photoreactor assembly comprising a reactor and a light source arrangement; wherein:
the light source arrangement comprises a plurality of light sources configured to generate light source radiation selected from one or more of UV radiation, visible radiation, and IR radiation, wherein each light source comprises a light emitting surface;
the reactor is configured for hosting a fluid to be treated with the light source radiation, wherein the reactor comprises one or more reactor walls;
at least one of the one or more reactor walls (a) defines wall cavities, (b) is configured in a radiation receiving relationship with the plurality of light sources, and (c) is transmissive for the light source radiation;
one or more of the light sources are at least partly configured in the wall cavities whereby the light emitting surfaces are within the wall cavities and the at least one of the one or more reactor walls at least partly encloses the light emitting surfaces;
wherein the plurality of light sources comprises solid state light sources;
wherein the wall cavities have an dome-like shape; and
wherein one or more of the following applies:
(i) the reactor comprises a reactor chamber, the reactor chamber has a reactor volume, the reactor volume hosts flow influencing elements, wherein the flow influencing elements are configured to increase turbulence, and wherein the flow influencing elements are configured within the reactor between adjacent wall cavities;
(ii)each wall cavity defines a reactor section surrounding the wall cavity, wherein adjacent reactor section are fluidly connected via inter reactor section channels, and wherein dimensions of the via inter reactor section channels are selected such, that a flow velocity of the fluid in the inter reactor section channels is higher than in the reactor sections.

2. The photoreactor assembly according to claim 1, wherein one or more of the wall cavities host a single light source.

3. The photoreactor assembly according to claim 1, wherein one or more of the wall cavities at least partly have the shape of a spherical cap.

4. The photoreactor assembly according to claim 1, wherein a plurality of the wall cavities at least partly host light sources, wherein the wall cavities are configured in a 2D array, wherein the wall cavities have a largest circular equivalent diameter D, wherein the light sources have a pitch p, wherein 1≤p/D≤2.

5. The photoreactor assembly according to claim 1, further comprising a reflector element, wherein the reflector element is configured to reflect light source radiation, and wherein the light emitting surfaces of the one or more of the light sources are configured between the at least one of the one or more reactor walls and the reflector element.

6. The photoreactor assembly according to claim 1, wherein at least part of the reactor is defined by two parallel configured reactor walls providing a reactor volume.

7. The photoreactor assembly according to claim 6, wherein the wall cavities penetrate into the reactor volume.

8. The photoreactor assembly according to claim 6, wherein the reactor walls have corrugated shapes at least partly defined by corrugations, wherein the corrugations comprise the wall cavities.

9. The photoreactor assembly according to claim 6, wherein the two parallel configured reactor walls define wall cavities and are configured in a radiation receiving relationship with the plurality of light sources wherein the reactor walls are transmissive for the light source radiation; wherein one or more of the light sources are at least partly configured in the wall cavities of each of the reactor walls, whereby the light emitting surfaces are within the wall cavities and the reactor walls at least partly enclose the light emitting surfaces.

10. The photoreactor assembly according to claim 9, wherein the reactor walls are configured sandwiched between the reflector elements.

11. (canceled)

12. (canceled)

13. The photoreactor assembly according to claim 1, wherein the plurality of light sources comprise one or more of chips-on-board light sources (COB), light emitting diodes (LEDs), laser diodes, and superluminescent diodes, and wherein one or more of a spectral power distribution of the light source radiation) and an intensity of the light source radiation is controllable, wherein the photoreactor assembly further comprises a control system, wherein the control system is configured to control the one or more of the spectral power distribution and the intensity of the light source radiation (along one or more dimensions of the reactor, wherein the one or more dimensions of the reactor are selected from the group of height, length, width, and diameter.

14. A method for treating a fluid with light source radiation, wherein the method comprises:
providing the fluid to be treated with the light source radiation in the reactor of the photoreactor assembly according to claim 1; and
irradiating the fluid with the light source radiation.

15. The method according to claim 14, comprising transporting the fluid through the reactor while irradiating the fluid with the light source radiation and controlling one or more of a spectral power distribution and an intensity of the light source radiation along one or more dimensions of the reactor, wherein the one or more dimensions of the reactor are selected from the group of height, length, width, and diameter.
